(19) United States
(12) Patent Application Publication
(10) Pub. No.: US 2018/0337859 A1
(43) Pub. Date: Nov. 22, 2018

(54) SYSTEMS AND METHODS FOR LOCAL PROCESSING OF NETWORK FRAMES IN A REFLECTOR

(71) Applicant: Avago Technologies General IP (Singapore) Pte. Ltd., Singapore (SG)

(72) Inventors: Israel MEILIK, Yakum (IL); Assaf SHACHAM, Yakum (IL)

(73) Assignee: Avago Technologies General IP (Singapore) Pte. Ltd., Singapore (SG)

(21) Appl. No.: 15/608,426

(22) Filed: May 30, 2017

Related U.S. Application Data
(60) Provisional application No. 62/506,893, filed on May 16, 2017.

(51) Int. Cl. H04L 12/803; H04L 1/22

(52) U.S. Cl. CPC H04L 47/125; H04L 65/605; H04L 1/22

(57) ABSTRACT

According to embodiments of the disclosed subject matter, a system electronic device can include circuitry configured to receive a frame from a sender via a network as outbound traffic. Next, the system electronic device can return the received frame to the sender as return traffic. Additionally, a copy of the outbound traffic frame can be generated for analysis via a statistics measurement component, the statistics measurement component being local to the reflector. Further, the system electronic device can measure, via the statistics measurement component, performance parameters corresponding to the outbound traffic frame.

### CROSS-REFERENCE TO RELATED APPLICATIONS

This application is based on, and claims the benefit of priority to, provisional application No. 62/506,893, filed May 16, 2017, the entire contents of which are incorporated herein by reference.

### FIELD OF THE DISCLOSURE

The present disclosure relates generally to a system and associated methodology for testing network performance.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

When testing network performance, for service activation or otherwise, a typical method of operation is using a network reflector. See, for example, Two-Way Active Measurement Protocol (TWAMP, RFC5357). In such a method, a session is established, assigning sender and reflector roles. The sender transmits frames, with data such as timestamps, sequence numbers, payload, and the like. The reflector returns the frames as quickly as possible, and possibly adds some data (e.g. its own timestamps, sequence numbers, etc.). The sender then receives the reflected frames, and analyzes them to measure network performance parameters including Information Rate (IR), Frame Loss Rate (FLR), Frame Transmission Delay (FTD), and Frame Delay Variation (FDV).

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

According to embodiments of the disclosed subject matter, a system electronic device can include circuitry configured to receive a frame from a sender via a network as outbound traffic. Next, the system electronic device can return the received frame to the sender as return traffic. Additionally, a copy of the outbound traffic frame can be generated for analysis via a statistics measurement component, the statistics measurement component being local to the reflector. Further, the system electronic device can measure, via the statistics measurement component, performance parameters corresponding to the outbound traffic frame.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 depicts an exemplary overview of a network performance testing system according to one or more aspects of the disclosed subject matter;

FIG. 2 depicts an exemplary reflector according to one or more aspects of the disclosed subject matter;

FIG. 3 is an algorithmic flow chart for processing frames in a reflector according to one or more aspects of the disclosed subject matter;

FIG. 4 is an algorithmic flow chart for processing frames in a sender according to one or more aspects of the disclosed subject matter; and

FIG. 5 depicts a hardware block diagram of a device (e.g., computer, server, or remote device) according to one or more aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

Referring now to the drawings, wherein like reference numerals designate identical or corresponding parts throughout the several views.

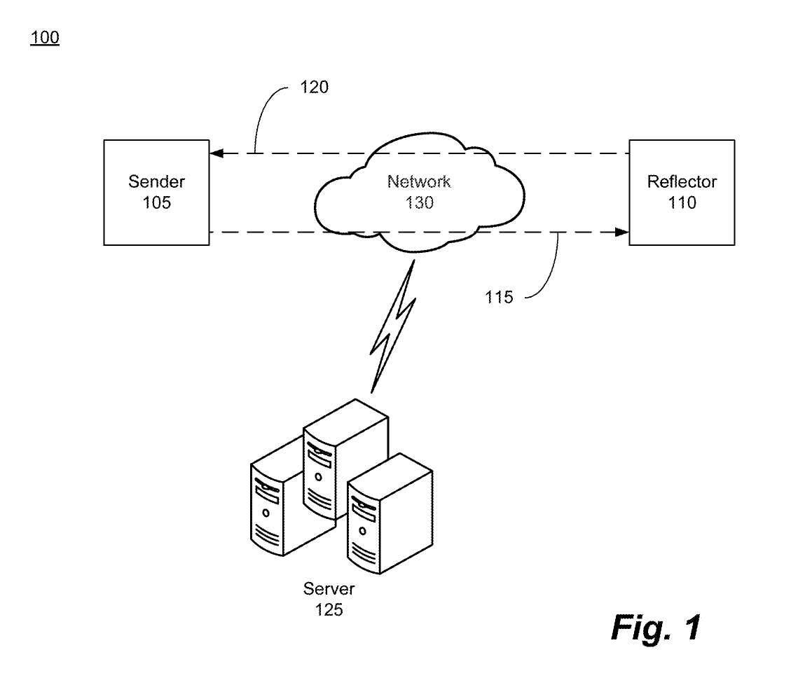

FIG. 1 depicts an exemplary overview of a network performance testing system 100 (herein referred to as system 100) according to one or more aspects of the disclosed subject matter. The system 100 can include a sender 105, a reflector 110, and a server 125 communicably coupled via a network 130. The sender 105 and the reflector 110 can communicate via an outbound path 115 and a return path 120. The outbound path 115 can correspond to information being transmitted from the sender 105 to the reflector 110. A frame transmitted from the sender 105 to the reflector 110 can be an outbound traffic frame. The return path 120 can correspond to information being transmitted from the reflector 110 to the sender 105. A frame transmitted from the reflector 110 to the sender 105 can be a return traffic frame. Additionally, the network can be made up of one or more senders 105, one or more reflectors 110, and one or more networks 130, for example, with each sender 105 and reflector 110 having unique outbound and return paths. In an embodiment, the reflector 110 can be a switch or router, for example.

The server 125 can represent one or more servers connected to the sender 105 and the reflector 110 via the network 130. In an embodiment, the server 125 can be a computer or remote device, for example. In an embodiment, the sender 105 or the reflector 110 may perform the role of the server 125. The server 125 can include processing circuitry to perform various processing for the system 100 including initiating network performance tests and receiving reports generated by sender 105 and the reflector 110, for example. Additionally, in an embodiment, the server 125 can receive, via the network 130, the results of frames analyzed at the sender 105 and results of frames analyzed at the reflector 110. The server 125 can then compare each frame analyzed at the sender 105 with the corresponding frame analyzed at the reflector 110. The comparison can be part of a network performance test and provide valuable insight into the performance of each component of the network, as further described herein. In an embodiment, the server 125 can be communicably coupled to one or more of the sender 105 and the reflector 110 via a different network. In other words, both the sender 105 and the reflector 110 collect statistics on all the frames that they process locally, and at the end of the network performance testing session, each of the sender 105 and the reflector 110 sends a statistical summary report to the server 125, wherein the server 125 may be the same device as the sender 105, the reflector 110, or the sever 125 may be a separate device.

The network 130 can represent one or more networks connecting the sender 105, the reflector 110, and the server 125. The network 130 can be a public network, such as the Internet, or a private network such as an LAN or WAN network, or any combination thereof and can also include PSTN or ISDN sub-networks. The network 130 can also be wired, such as an Ethernet network or a USB port, or can be wireless such as a cellular network including EDGE, 3G 4G, and LTE/LTE-A wireless cellular systems. The wireless network can also be Wi-Fi, Bluetooth, or any other wireless form of communication that is known.

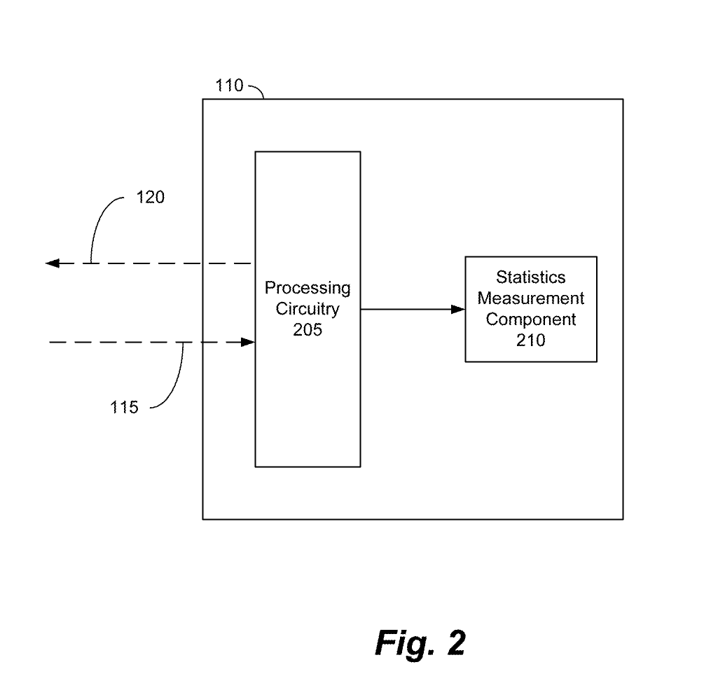

FIG. 2 depicts an exemplary overview of the reflector 110 according to one or more aspects of the disclosed subject matter. The reflector 110 can include processing circuitry 205 communicably coupled to a statistics measurement component 210. The processing circuitry 205 can be configured to copy each received outbound traffic frame (e.g., frames received via outbound path 115) in a network performance testing session. Additionally, the processing circuitry 205 can return the received frame to the sender 105. The statistics measurement component 210 can provide added functionality configured to analyze each frame received in the reflector 110. For example, the processing circuitry 205 may receive the frame from the sender 105 via the outbound path 115, copy the received frame, return the original received frame to the sender 105, and forward the copied frame to the statistics measurement component 210. The copied frame can be received by a statistics measurement component 210, which can process and analyze the frame. The analysis of the frame may include extracting timestamps, sequence numbers, and other metadata, measuring the frame's time of arrival, identifying lost, misordered, and misdirected frames, and calculating performance parameters including information rate (IR), frame loss rate (FLR), frame transmission delay (FTD), and frame delay variation (FDV). The analysis can be performed on each of the one or more frames in a network performance testing session. Additionally, the statistics measurement component 210 may be an independent component that can be coupled to existing reflectors, for example, to add the functionality included in the reflector 110 as described herein. For example, an existing reflector can receive the statistics measurement component 210 as all or part of a hardware and/or software upgrade to be able to analyze frames in a network performance testing session. As a result, existing networks with one or more senders and reflectors can be upgraded to include reflectors such as reflector 110 via a hardware and/or software upgrade to reflectors already existing in the network, thereby improving any network performance testing. Once a network performance testing session is completed, a report may be generated containing the statistics collected from frames belonging to the session. The generated report may be transmitted to the server 125, for example, where the server may be controlled by an entity controlling the test session. The advantages of the system 100 include measuring frame loss rate and information rate more accurately by measuring the frame loss rate and information rate separately between outbound traffic (e.g., frames transmitted via the outbound path 115) and return traffic (e.g., frames transmitted via the return path 120). Additionally, various delay measurements of the outbound traffic become more accurate because information from the packets can be measured at the reflector rather than waiting to measure after the round trip back to the sender where information could be lost on the return trip. In other words, it can be determined which component of the system 100 is responsible for frame loss when testing network performance, for example.

In some implementations, the specific measurements on the outbound path 115 may vary between information rate, frame loss rate, frame transmission delay (min, max, and average), and frame delay variation (min, max, average, and histogram). The user may also have the flexibility to enable/disable measurements in the reflector 110, and the user may further select whether to include or exclude the measurements in the report generated after the network performance testing session is completed. Additionally, the existing TWAMP-Control protocol can be enhanced to instruct the creation of flow-tracking data-structures in the reflector 110. For example, TWAMP-Control Protocol can define the parameters of the histogram in the FDV measurement (e.g., number of bins and their limits). It can also define which types of measurements are to be conducted on each flow, to facilitate efficient use of measurement resources.

Improvements over existing technology include performing measurements in the reflector 110. For example, TWAMP (RFC5357) defines the roles of a sender and a reflector, but does not specify any measurements to be done in the reflector (e.g., reflector 110). Additionally, Service Activation Test standards (ITU Y.1563/1564, MEF48) define performance measurement criteria but do not discuss reflector functionality. In cases where the return path 120 has a high frame loss rate, by performing measurements in the reflector 110, traffic in the system 100 can be analyzed before it experiences the high loss rate when returned to the sender 105. For example, there could be no packet loss in the outbound path 115 from the sender 110 to the reflector 105, and high packet loss in the return path 120 from the reflector 110 to the sender 105. Accordingly, by copying the frame and analyzing it at the reflector 110, the component in the system 100 responsible for the packet loss can be determined. In other words, there is a significant diagnostic advantage in testing network performance when performing measurements in the reflector 110 as described herein.

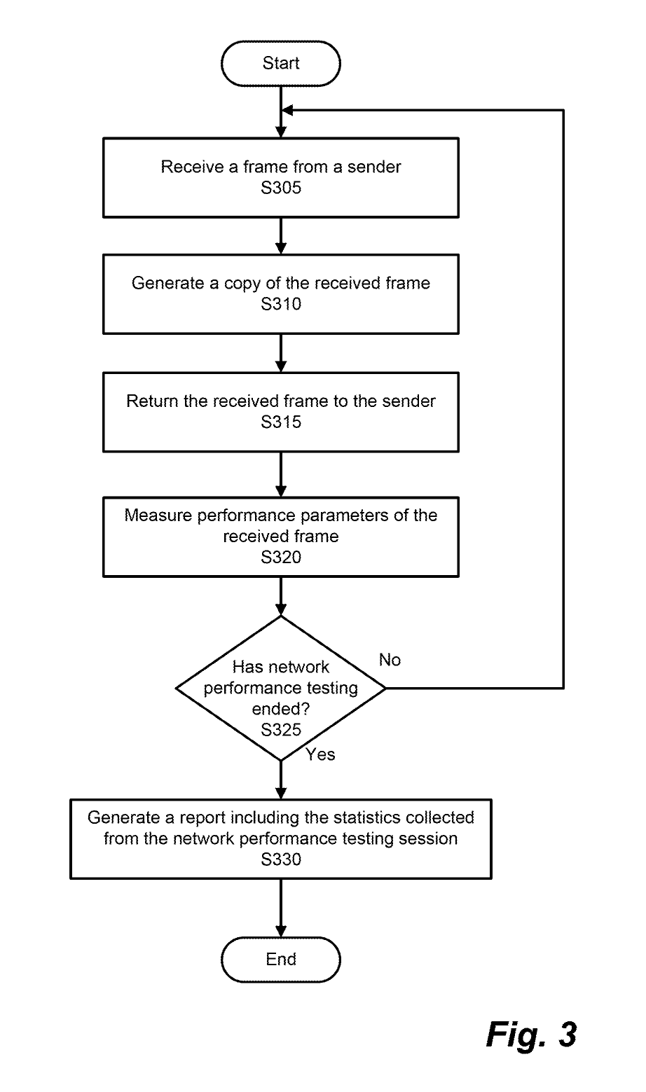

FIG. 3 is an algorithmic flow chart for processing frames in a reflector (e.g., reflector 110) according to one or more aspects of the disclosed subject matter. The processing of FIG. 3 may be performed by the reflector 110, for example. Alternatively, or additionally, the processing of FIG. 3 may be performed by another device.

In S305, the reflector 110 can receive a frame from the sender 105 as part of a network performance test, for example. More specifically, the processing circuitry 205 of the reflector 110 can receive the frame.

In S310, the processing circuitry 205 of the reflector 110 can generate a copy of the frame received in S305. The copy of the frame can be transmitted to the statistics measurement component 210 of the reflector 110 for further analysis of the frame. The analysis can include measuring the frame's time of arrival, extracting time stamps, sequence numbers, classification information, and other metadata, identify lost, misordered, and misdirected frames, and measure various performance parameters.

In S315, the reflector 110 can return the frame received in S305 to the sender 105. More specifically, the processing circuitry 205 can instruct the reflector 110 to return the frame to the sender 110 to complete a round trip for the frame. Additionally, the reflector 110 may add its own data (e.g., timestamps, sequence numbers, etc.) to the frame. The round trip for the frame may be part of a network performance testing session, for example, and the sender 105 may perform further analysis on the frame as part of the network performance testing session.

In S320, the statistics measurement component of the reflector 110 can measure performance parameters of the copy of the frame generated in S315. The performance parameters measured for each received frame can include information rate (IR), frame loss rate (FLR), a min, max, and average frame transmission delay (FTD), and a min, max, average, and histogram of frame delay variation (FDV).

In S325, it can be determined if network performance testing has ended, either after receiving an “end of session” message from the server 125, or by reaching a certain number of frames, for example. Each frame received by the reflector 110 in S305 can be part of a network performance testing session. The network performance testing session can include one or more frames, for example. If it is determined that the network performance testing session has not ended, the process can return to S305 to receive the next frame in the network testing session. However, if it is determined that the network performance testing session has ended, a report for the network performance testing session can be generated in S330.

In S330, a report of the frames received at the reflector 110 during the network performance testing session can be generated by the statistics measurement component 210, for example. The report can be collected by an entity controlling the test session, for example, and the information in the report can further be included in a report sent to a user (i.e., user performing the network performance testing session). In an embodiment, the generated report can be transmitted to the server 125 for collection and/or any further processing. The report can include the statistical summary of the performance metrics measured, or statistics collected for each of the frames from the network performance testing session, such as the analysis performed by the statistics measurement component described in S315. After the report is generated in S330, the process can end.

It should be appreciated that one or more of the steps in FIG. 3 may be performed simultaneously. Additionally, one or more of the steps may be performed in a different order.

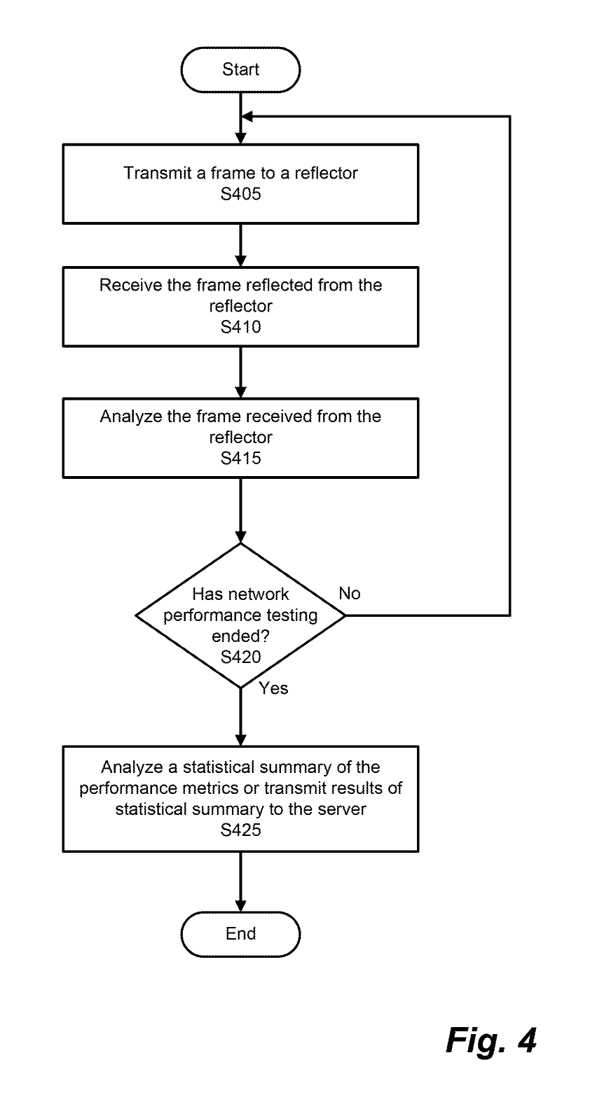

FIG. 4 is an algorithmic flow chart for processing frames in the sender 105 according to one or more aspects of the disclosed subject matter.

In S405, a frame can be transmitted to the reflector 110 from the sender 105 via the network 130 as part of a network performance test, for example.

In S410, the frame that was transmitted in S405 can be received from the reflector 110 as the frame was reflected from the reflector 110 as part of the network performance test, for example.

In S415, the reflected frame that was received in S410 can be analyzed. The analysis can include measuring network performance parameters including information rate, frame loss rate, frame transmission delay, frame delay variation, and the like, for example.

In S420, it can be determined if network performance testing has ended. Each frame transmitted by the sender 105 in S405 can be part of a network performance testing session. The network performance testing session can include one or more frames, for example. If it is determined that the network performance testing session has not ended, the process can return to S405 to transmit the next frame in the network testing session. However, if it is determined that the network performance testing session has ended, a statistical summary of the performance metrics can be analyzed, or the results of each frame analyzed at the sender 105 can be transmitted in S425.

In S425, a statistical summary of the performance metrics of all the frames received at the sender 105 can be analyzed, or the statistical summary of the frames analyzed at the sender 105 can be transmitted to the server 125. In an embodiment, when the statistical summary of the performance metrics are analyzed at the sender 105, the sender 105 may be operating as the server 125 such that the frame results may be compared to copies of corresponding frames that were analyzed at the reflector 110. If frame results are transmitted, the frame results may be transmitted to the server 125 where they can be compared to copies of corresponding frames that were analyzed at the reflector 110. As a result, a summary of the analyses from the sender 105 and the reflector 110 is collected at the server 125 and can then be included in a final report of the network performance testing session generated by the server 125.

In an embodiment, the results of the analysis of each frame analyzed at the sender 105 can be transmitted to the server 125. The server 125 can then compare each frame analyzed at the sender 105 with the results of each corresponding frame analyzed at the reflector 110, where the statistics of each frame analyzed at the reflector 110 are indicated in the report generated in S330 and received by the server 125. After the results of each frame analyzed at the sender 105 are transmitted (e.g., to one or more of the reflector 110 and the server 125), the process can end.

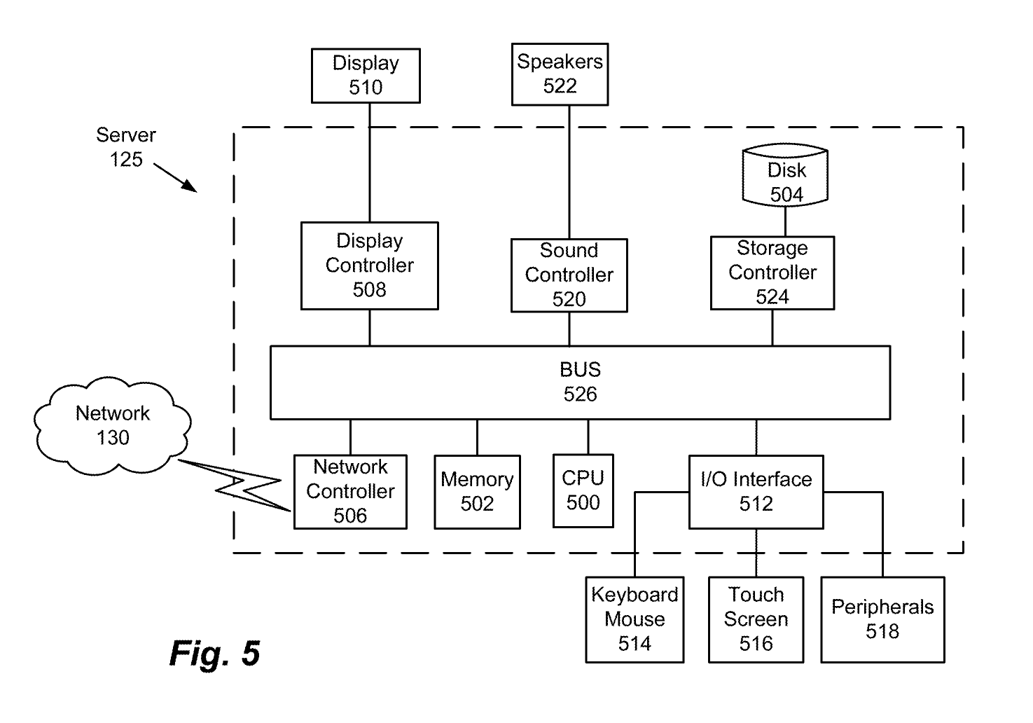

Next, a hardware description of a computer/device (e.g., the server 125) according to exemplary embodiments is described with reference to FIG. 5. In FIG. 5, the server 125 includes a CPU 500 which performs one or more of the processes described above/below.

The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 125 communicates, such as a server or computer.

Further, the claimed advancements may be provided as a utility application, background daemon, or component of an operating system, or combination thereof, executing in conjunction with CPU 500 and an operating system such as Microsoft Windows, UNIX, Solaris, LINUX, Apple MAC-OS and other systems known to those skilled in the art.

The hardware elements in order to achieve the server 125 may be realized by various circuitry elements. Further, each of the functions of the above described embodiments may be implemented by circuitry, which includes one or more processing circuits. A processing circuit includes a particularly programmed processor, for example, processor (CPU) 500, as shown in FIG. 5. A processing circuit also includes devices such as an application specific integrated circuit (ASIC) and conventional circuit components arranged to perform the recited functions.

In FIG. 5, the server 125 includes a CPU 500 which performs the processes described above. The server 125 may be a general-purpose computer or a particular, special-purpose machine. In one embodiment, the server 125 becomes a particular, special-purpose machine when the processor 500 is programmed to perform network performance testing (and in particular, any of the processes discussed with reference to FIGS. 3 and 4).

Alternatively, or additionally, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above.

The server 125 in FIG. 5 also includes a network controller 506, such as an Intel Ethernet PRO network interface card from Intel Corporation of America, for interfacing with network 130. As can be appreciated, the network 130 can be a public network, such as the Internet, or a private network such as an LAN or WAN network, or any combination thereof and can also include PSTN or ISDN sub-networks. The network 130 can also be wired, such as an Ethernet network, or can be wireless such as a cellular network including EDGE, 3G and 4G wireless cellular systems. The wireless network can also be WiFi, Bluetooth, or any other wireless form of communication that is known.

The server 125 further includes a display controller 508, such as a graphics card or graphics adaptor for interfacing with display 510, such as a monitor. A general purpose I/O interface 512 interfaces with a keyboard and/or mouse 514 as well as a touch screen panel 516 on or separate from display 510. General purpose I/O0 interface also connects to a variety of peripherals 518 including printers and scanners.

A sound controller 520 is also provided in the server 125 to interface with speakers/microphone 522 thereby providing sounds and/or music.

The general purpose storage controller 524 connects the storage medium disk 504 with communication bus 526, which may be an ISA, EISA, VESA, PCI, or similar, for interconnecting all of the components of the server 125. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The system 100 has several advantages including enhanced testing of network performance. In existing protocols, such as TWAMP, for example, the reflector is not expected to track the session or process frames for performance measurements. Therefore, the measurement results may be lacking when the return FLR (i.e., rate of frames lost on the path from a reflector to a sender 105) is high, for example. Additionally, accurate outbound FLR (i.e., frames lost on the path from a sender to a reflector) measurement becomes difficult, and delay measurements (FTD, FDV) on the outbound path may have a lower accuracy because information may be lost in packets which are lost in the return path. To the contrary, the system 100 allows the FLR to be measured separately to the outbound FLR (i.e., frames lost on the path from the sender 105 to the reflector 110) and return FLR (i.e., frames lost on the path from the reflector 110 to the sender 105). Additionally, delay measurements (FTD, FDV) on the outbound path 115 become more accurate because information from the packets which could be lost later on the return path 120 is now available.

Further, the hardware and software elements of the reflector 110 that allow the reflector 110 to analyze received frames may be incorporated into existing reflectors. In other words, reflectors in an existing network may receive one or more of a hardware upgrade and software update to allow the reflector to analyze received frames. As a result, the quality of network performance testing of existing networks can be significantly improved with cost effective upgrades to existing reflectors. Alternatively, or additionally, reflectors that include the hardware and/or software for the enhanced network performance testing may be manufactured specifically to be added to existing networks and/or used in the setup of new networks.

Another advantage of the system 100 includes the ability to compare the analysis and performance measured at the reflector 105 with analysis of the frame at the sender. As the information generated in a network performance report (e.g., in S330) may be supplemental and/or additional to analysis of the frame performed at the sender 105, the information from the analysis performed in the reflector 110 may be compared to the information determined at the sender 105 to provide further analysis of the performance of the network, for example. In other words, the sender 105 can perform measurements and collect statistics on a frame reflected from the reflector 110, which corresponds to information about the round trip of the frame. The round trip information can be compared to the information from the reflector 110 (e.g., the report generated in S330) to determine which component of the system 100 is responsible for frame loss when testing network performance. Additionally, in an embodiment, both the sender 105 and the reflector 110 can send a statistical summary report to the server 125, which will compare and present the final results of the network performance testing session. Additionally, in an embodiment, the sender 105 and the server 125 are the same device. In other words, the round trip information may be compared to the information from the reflector 110 at the sender 105, and the sender 105 may generate a final report including a statistical summary of the performance metrics from the network performance testing session.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

1. A system electronic device comprising:
circuitry configured to:
receive a frame from a sender via a network as outbound traffic,
return the received frame to the sender as return traffic,
generate a copy of the outbound traffic frame for analysis, and
measure performance parameters corresponding to the outbound traffic frame.

2. The system electronic device of claim 1, wherein the processing circuitry is further configured to
determine when a network performance testing session has ended, and
in response to determining that the network performance testing session has ended, generate a report including the statistics collected from frames belonging to a network performance testing session, wherein the network performance testing session includes one or more frames.

3. The system electronic device of claim 2, wherein the processing circuitry is further configured to
extract time stamps from each outbound traffic frame in the network performance testing session.

4. The system electronic device of claim 2, wherein the processing circuitry is further configured to
extract sequence numbers from each outbound traffic frame in the network performance testing session.

5. The system electronic device of claim 3, wherein the processing circuitry is further configured to
calculate a transmission delay based on the time stamps from each outbound traffic frame in the network performance testing session.

6. The system electronic device of claim 2, wherein the processing circuitry is further configured to
identify one or more of lost, misordered, and misdirected outbound traffic frames from the network performance testing session.

7. The system electronic device of claim 2, wherein the statistics collected and included in the report include one or more of information rate (IR), frame loss rate (FLR), frame transmission delay (FTD), and frame delay variation (FDV).

8. The system electronic device of claim 1, wherein the processing circuitry is further configured to
receive instructions to perform one or more of enabling and disabling the measuring of performance parameters of the outbound traffic frame in the reflector.

9. The system electronic device of claim 2, wherein the processing circuitry is further configured to
receive instructions corresponding to one or more of including and excluding the performance parameters in the generated report.

10. A network reflector, comprising:
processing circuitry configured to
receive a frame from a sender via a network as outbound traffic during a network performance testing session,
add data including timestamps and sequence numbers to the received frame and return the received frame to the sender as return traffic,
generate a copy of the outbound traffic frame to be stored in memory at the reflector for analysis,
measure performance parameters corresponding to the outbound traffic frame, and
transmit a statistical summary of the performance metrics to a server coupled to the network reflector via the network when the network performance testing session ends.

11. The network reflector of claim 10, wherein the statistical summary of the performance metrics includes measuring information rate (IR), frame loss rate (FLR), frame transmission delay (FTD), and frame delay variation (FDV) of each frame in the network performance testing session.

12. The network reflector of claim 10, wherein the performance parameters corresponding to the outbound traffic frame include one or more of information rate (IR), frame loss rate (FLR), and frame transmission delay (FTD), and frame delay variation (FDV).

13. The network reflector of claim 10, wherein the processing circuitry is further configured to
identify one or more of lost, misordered, and misdirected outbound traffic frames from the network performance testing session.

14. A method, comprising:
receiving, via processing circuitry, a frame from a sender via a network as outbound traffic during a network performance testing session;
returning, via the processing circuitry, the received frame to the sender as return traffic;
generating, via the processing circuitry, a copy of the outbound traffic frame for analysis local to a reflector, the reflector being coupled to the sender via a network;
measuring, via the processing circuitry, performance parameters corresponding to the outbound traffic frame;
determining, via processing circuitry, whether the network performance testing session has ended; and
generating, via processing circuitry, a report including statistics measured during the network performance testing session.

15. The method of claim 14, further comprising:
transmitting the generated report to the sender coupled to the reflector via the network.

16. The method of claim 14, wherein the statistics measured during the network performance testing session include identifying one or more of lost, misordered, and misdirected outbound traffic frames from the network performance testing session.

17. The method of claim 16, wherein the statistics measured during the network performance testing session further include the measured performance parameters corresponding to the outbound traffic frame, wherein the performance parameters include one or more of information rate (IR), frame loss rate (FLR), and frame transmission delay (FTD), and frame delay variation (FDV).

18. The method of claim 15, wherein the sender compares the report generated by the reflector with round trip information for each frame received at the server as return traffic to generate a final report of the network performance testing session.

19. The method of claim 14, further comprising:
transmitting the generated report to a server communicably coupled to the sender and the reflector via the network.

20. The method of claim 14, further comprising:
identifying a component of the network responsible for one or more of lost, misordered, and misdirected frames as a result of the network performance testing session.
